(19) United States
(12) Patent Application Publication
(10) Pub. No.: US 2024/0031880 A1
(43) Pub. Date: Jan. 25, 2024

(54) INTEGRATED ACCESS AND BACKHAUL DONOR MIGRATION METHODS AND SYSTEMS

(71) Applicant: ZTE Corporation, Shenzhen (CN)

(72) Inventors: Ying HUANG, Shenzhen (CN); Lin CHEN, Shenzhen (CN)

(21) Appl. No.: 18/476,912

(22) Filed: Sep. 28, 2023

Related U.S. Application Data
(63) Continuation of application No. PCT/CN2021/084990, filed on Apr. 1, 2021.

(51) Int. Cl. H04W 36/00; H04W 36/08

(52) U.S. Cl. CPC H04W 36/0055; H04W 36/08

(57) ABSTRACT

Methods, systems, and devices for integrated access and backhaul (IAB) donor migration in mobile and cellular networks are described. An example method for wireless communication includes transmitting, by a first IAB donor to a second IAB donor, an Xn Application Protocol (XnAP) message comprising an Internet Protocol (IP) address request information, and receiving, from the second IAB donor, an IP address information. Another example method for wireless communication includes transmitting, by a first network node to a second network node, a message comprising a transmission action indicator information, wherein the transmission action indicator information configures the second network node to perform one or more transmission actions to a wireless device.

### CROSS REFERENCE TO RELATED APPLICATIONS

This patent document is a continuation of and claims benefit of priority to International Patent Application No. PCT/CN2021/084990, filed on Apr. 1, 2021. The entire content of the before-mentioned patent application is incorporated by reference as part of the disclosure of this application.

### TECHNICAL FIELD

This document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques will provide support for integrated access and backhaul (IAB), which enables wireless backhauling via New Radio (NR) and flexible and very dense deployment of NR cells while reducing the need for wireline transport infrastructure.

### SUMMARY

This document relates to methods, systems, and devices for integrated access and backhaul (IAB) donor migration for mobile communications, including 5th Generation (5G) and New Radio (NR) communication systems.

In one exemplary aspect, a wireless communication method is disclosed. The method includes transmitting, by a first integrated access and backhaul (IAB) donor to a second IAB donor, an Xn Application Protocol (XnAP) message comprising an Internet Protocol (IP) address request information, and receiving, from the second IAB donor, an IP address information.

In another exemplary aspect, a wireless communication method is disclosed. The method includes transmitting, by a first integrated access and backhaul (IAB) donor to an IAB node, an F1 Application Protocol (F1AP) message comprising an Internet Protocol (IP) address information, wherein the IP address information comprises at least one of an IP address information of the IAB node, an IP address information of the first IAB donor, and an IP address information of a second IAB donor.

In yet another exemplary aspect, a wireless communication method is disclosed. The method includes transmitting, by an integrated access and backhaul (IAB) distributed unit (DU) to an IAB donor, a control message comprising an Internet Protocol (IP) address information of the IAB DU.

In yet another exemplary aspect, a wireless communication method is disclosed. The method includes transmitting, by a first network node to a second network node, a control message comprising an Internet Protocol (IP) address information.

In yet another exemplary aspect, a wireless communication method is disclosed. The method includes transmitting, by a first network node to a second network node, a message comprising a transmission action indicator information, wherein the transmission action indicator information configures the second network node to perform one or more transmission actions to a wireless device.

In yet another exemplary aspect, the above-described methods are embodied in the form of processor-executable code and stored in a computer-readable program medium.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1A shows an example of an Integrated Access and Backhaul (IAB) network.

FIG. 1B shows an example of an IAB user plane protocol stack.

FIG. 2 shows an example of inter-CU migration.

FIG. 3 shows an example of the separation of the central unit (CU) control plane (CP) and user plane (UP) in a g-NodeB (gNB).

FIGS. 4-8 show examples of wireless communication methods corresponding to some embodiments of the presently disclosed technology.

FIG. 9 is a block diagram representation of a portion of an apparatus that can be configured to implement some embodiments of the presently disclosed technology.

### DETAILED DESCRIPTION

As the number of applications and services for digital data continues to explode, the demands and challenges placed on network resources and operators will continue to increase. Being able to deliver a wide variety of network performance characteristics that future services will demand is one of the primary technical challenges faced by service providers today. The performance requirements placed on the network will demand connectivity in terms of data rate, latency, QOS, security, availability, and many other parameters, all of which will vary from one service to the next. Thus, enabling a network to allocate resources in a flexible manner to provide customized connectivity for each different type of service will greatly enhance the network's ability to meet future demands.

To meet these demands, the development of 5th Generation (5G) mobile wireless technologies and standards are well underway. One such technology is a split network architecture wherein the Radio Access Network (RAN) functionality is split between a Central Unit (CU) and multiple Distributed Units (DUs). For example, RAN functions may be split at the point between the Packet Data Convergence Protocol (PDCP) layer and the Radio Link Control (RLC) layer of the 5G protocol stack, wherein DUs will handle all processes up to and including the RLC layer functions and the CU will handle PDCP layer and higher layer functions prior to the core network. This disaggregation of RAN functions will provide numerous advantageous to mobile network operators. For example, through the isolation of the stack from the PDCP layer and upwards, the CU will be able to act as a cloud-based convergence point among multiple heterogeneous technologies in the provisioned networks and hence will be able to serve multiple heterogeneous DUs.

Another technology being developed for 5G networks is an Integrated Access and Backhaul (IAB) architecture for providing high-speed wireless backhaul to cell sites (e.g., base stations). As data demands and the number of cell sites increase, it is becoming more difficult to provide traditional fiber optic backhaul access to each cell site, which is especially true for small cell base stations. Under the IAB architecture, the same infrastructure and resources (e.g., IAB nodes) can be used to provide both access and backhaul to support User Equipment (UE) Packet Data Unit (PDU) sessions, for example. The IAB architecture for New Radio (NR) networks will provide wireless backhaul and relay links enabling flexible and dense deployment of NR cells without the need to increase the density of the transport network proportionately. Additionally, IAB technologies will allow for easier deployment of a dense network of self-backhauled NR cells in a more integrated and robust manner. For example, the IAB technology in the 5G NR network will support a multi-hop relay system, where the network topology also supports redundant connections.

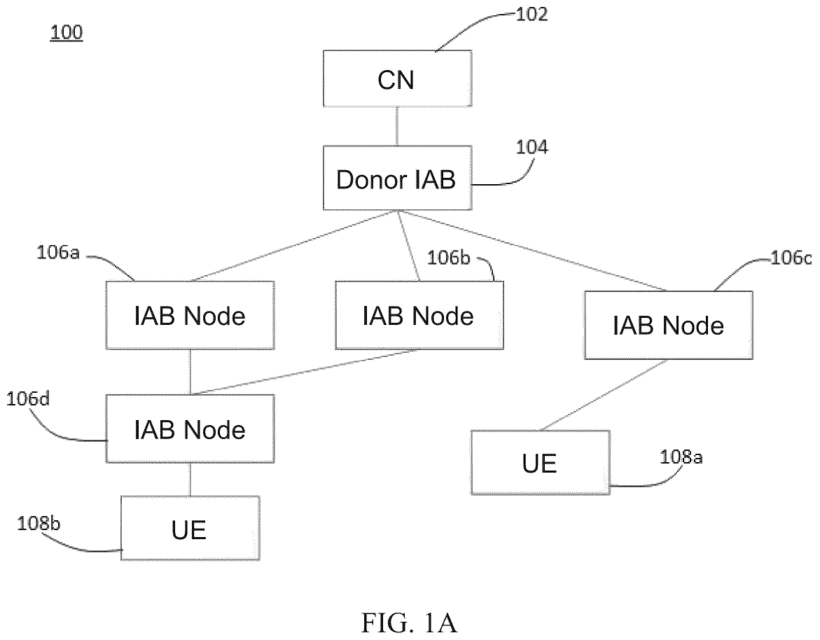

FIG. 1A illustrates a block diagram of an IAB architecture network 100 wherein a core network 102 is connected to a donor IAB node 104. As used herein, the term “connected” refers to a wired or cabled connection (e.g., a fiber optic cable) between two nodes or devices. The donor IAB node 104 is wirelessly coupled to a plurality of intermediate IAB nodes 106a and 106b and two serving IAB nodes 106c and 106d. As used herein, the term “coupled” refers to direct or indirect and wired or wireless communications between two nodes or devices.

As shown in FIG. 1A, serving IAB nodes 106c and 106d are directly coupled to UEs 108a and 108b, respectively, and function as the serving cell site base stations or access points for the UEs 108a and 108b. The UEs 108a and 108b are referred to herein as “access UEs.” The serving IAB nodes 106c and 106d also function as relay and can forward their respective UE signals to their respective next uplink nodes in the transmission path, and forward downlink signals to their respective UEs 108a and 108b. As shown in FIG. 1A, the serving IAB node 106c can forward uplink UE signals to one or both of the intermediate IAB nodes 106a and 106b, and receive downlink UE signals from one or both of the intermediate IAB nodes 106a and 106b. The intermediate IAB nodes 106a and 106b can forward uplink UE signals to the donor IAB node 104, and forward downlink signals to the serving IAB node 106d. The serving IAB node 106c can forward uplink UE signals to the donor IAB node 104, which can then forward all received signals to the core network 102, and can forward downlink signals from the donor IAB node 104 to the access UE 108a.

Each of the IAB nodes 106a-106d can have two functions: a base station (BS) function and a mobile terminal (MT) function. The BS function means the IAB node can work like a base station to provide the radio access function for a UE. As used herein, the “BS part” of an IAB node refers to that portion of the IAB node, including all hardware, firmware and/or software related to performing the BS functions of the IAB node. The MT function means the IAB node can work like a mobile terminal to be controlled and scheduled by the IAB donor node or an upper IAB node. As used herein the “MT part” of an IAB node refers to that portion of the IAB node, including all hardware, firmware and/or software related to performing the MT functions of the IAB node.

Referring still to FIG. 1A, if the network 100 also implements a split architecture, the donor IAB node 104 would be replaced by a donor CU (not shown) connected to the core network 102 and a donor DU (not shown) connected to the donor CU. Each of the IAB nodes 106a-106d would be coupled to the donor DU in similar fashion to their coupling to the donor IAB node 104, as shown in FIG. 1A.

In a split architecture network, each of the IAB nodes 106a-106d can have two functions: a DU function and a mobile terminal (MT) function. The DU function means the IAB node can work like a DU to provide the predetermined DU functions for a UE. As used herein, the “DU part” of an IAB node refers to that portion of the IAB node, including all hardware, firmware and/or software related to performing the DU functions of the IAB node. The MT function and MT part of an IAB node in a split architecture network is the same as described above for a non-split architecture network.

FIG. 1B shows the IAB user plane protocol stack between IAB-DU and IAB-donor-CU. F1-U use an IP transport layer between IAB-DU and IAB-donor-CU. The IP layer may be further security-protected. On the wireless backhaul, the IP layer is carried over the backhaul adaptation protocol (BAP) sublayer, which enables routing and bearer mapping over multiple hops. On each backhaul link, the BAP PDUs are carried by BH RLC channels. Multiple BH RLC channels can be configured on each BH link to allow traffic prioritization and QoS enforcement.

In this document, the following terminology is used.

IAB-donor: gNB that provides network access to UEs via a network of backhaul and access links.

IAB-donor-CU: the gNB-CU of an IAB-donor, terminating the F1 interface towards IAB-nodes and IAB-donor-DU.

IAB-donor-DU: the gNB-DU of an IAB-donor, hosting the IAB BAP sublayer (as defined in TS 38.340), providing wireless backhaul to IAB-nodes.

IAB-DU: gNB-DU functionality supported by the IAB-node to terminate the NR access interface to UEs and next-hop IAB-nodes, and to terminate the F1 protocol to the gNB-CU functionality, as defined in TS 38.401, on the IAB-donor.

IAB-MT: IAB-node function that terminates the Uu interface to the parent node using the procedures and behaviours specified for UEs unless stated otherwise. IAB-MT function used in 38-series of 3GPP Specifications corresponds to IAB-UE function defined in TS 23.501.

IAB-node: RAN node that supports NR access links to UEs and NR backhaul links to parent nodes and child nodes. The IAB-node does not support backhauling via LTE.

Child node: IAB-DU's and IAB-donor-DU's next hop neighbour node; the child node is also an IAB-node.

Parent node: IAB-MTs next hop neighbour node; the parent node can be IAB-node or IAB-donor-DU

Upstream: Direction toward parent node in IAB-topology.

Downstream: Direction toward child node or UE in IAB-topology.

Existing IAB systems employ intra-donor CU migration, in which both the source node and the target node are served by the same IAB donor CU. One of the challenges, raised by the implementation of the split architecture and the IAB architecture technologies in the 5G network, is a solution for inter-donor CU migration.

Embodiments of the presently disclosed technology describe methods, systems, and devices for integrated access and backhaul (IAB) donor migration. In an example, the source IAB donor CU and target IAB donor CU exchange IP address related information. In another example, the donor CU and IAB-DU exchange IP address related information. In yet another example, the CU-CP and CU-UP exchange IP address related information.

The present document uses section headings and sub-headings for facilitating easy understanding and not for limiting the scope of the disclosed techniques and embodiments to certain sections. Accordingly, embodiments disclosed in different sections can be used with each other. Furthermore, the present document uses examples from the 3GPP New Radio (NR) network architecture and 5G protocol only to facilitate understanding and the disclosed techniques and embodiments may be practiced in other wireless systems that use different communication protocols than the 3GPP protocols.

Overview of Inter-Donor CU Migration

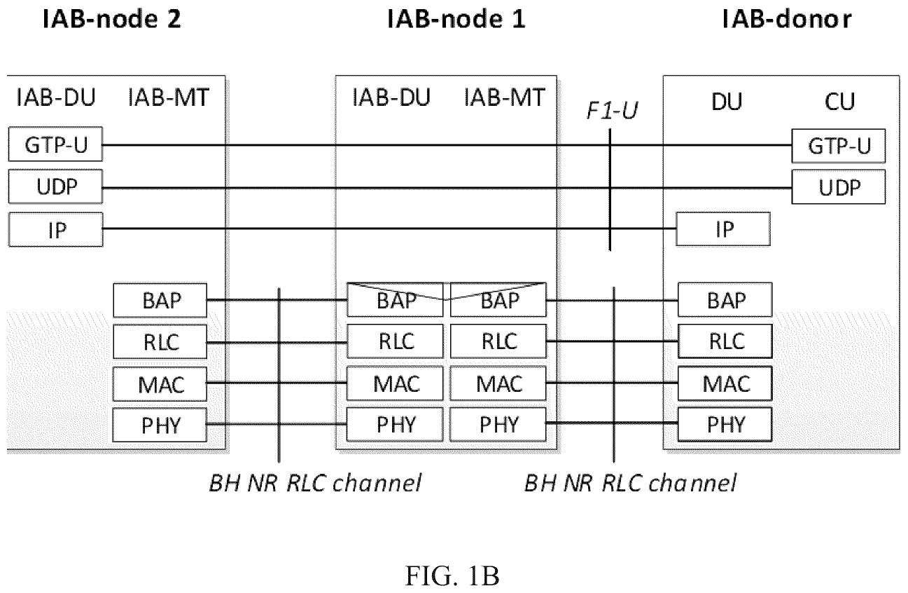

During an inter-donor CU migration procedure, the migrating IAB-node's source parent node is served by a different IAB-donor-CU than the target parent-node. FIG. 2 shows an example of an inter-donor CU (or inter-CU or inter-donor) migration. As shown therein, IAB-node 3 migrates between IAB-donor-CU 1 and IAB-donor-CU 2. In some embodiments, a Dual Active Protocol Stack (DAPS)-like handover or a conditional handover (CHO) could be utilized for the migration.

Examples of a Target Donor CU Obtaining IP Address Information

In some embodiments, during inter-donor migration, if the migrating IAB-node's source parent node is served by a different IAB-donor-DU than the target parent-node, a new IP address should be used by the migrating IAB node and/or donor CU for the IPsec tunnel that is established between the migrating IAB node and the donor CU via the target donor DU. Because new IP addresses typically anchor at a target donor DU, new IP addresses could be allocated by a target donor DU or a target donor CU or via the Operations, Administration and Maintenance (OAM) framework.

In some embodiments, a new IP address can be used by a descendant node and/or a donor CU for the IPsec tunnel established between the descendant node and the donor CU via the target donor DU.

One of the technical problems solved by embodiments of the disclosed technology is how the target donor CU obtained IP address request information.
(1) In some embodiments, the source donor CU includes the IP address request information in a Radio Resource Control (RRC) Context Information Element (IE) in an Xn Application Protocol (XnAP) handover request message, and sends it to the target donor CU.
(2) In some embodiments, the source donor CU includes the IP address request information in a HandoverPreparationlnformation message in the XnAP handover request message and send it to the target donor CU.
(3) In some embodiments, the IP address request information is included explicitly in the XnAP handover request message, which is sent from the source donor CU to the target donor CU.
(4) In some embodiments, the IP address request information is included in a new XnAP message, which is sent from the source donor CU to the target donor CU.

In the embodiments described above, the IP address request information includes at least one of the following:
The number of the requested IPv4 addresses per specific usage
The number of the requested IPv6 addresses per specific usage
The prefixes of requested IPv6 addresses per specific usage
   In the above, the specific usages include one or more of F1-C traffic, F1-U traffic, non-F1 traffic, and all traffic.
Old IPv4 address(es)
Old IPv6 address(es)
Old IPv6 prefix(es)

In some embodiments, after receiving the IP address request information, the target donor CU allocates the IP address as needed. In other embodiments, the target donor CU sends the IP address request information to the target donor DU, which allocates the IP address as needed.

Examples of a Donor CU and IAB-DU Obtaining IP Address Information

One of the technical problems solved by embodiments of the disclosed technology is how the IAB-DU obtains its updated IP address information.
(1) In some embodiments, the donor CU sends the IAB-DU's updated IP address information via an RRC message, e.g., RRCreconfiguration message.
(2) In some embodiments, the donor CU sends the IAB-DU's updated IP address information via an F1 Application Protocol (F1AP) message, e.g., GNB-CU CONFIGURATION UPDATE or GNB-DU CONFIGURATION UPDATE ACKNOWLEDGE message.

Another of the technical problems solved by embodiments of the disclosed technology is how the IAB-DU obtains the source donor CU's updated IP address information.
(1) In some embodiments, the donor CU send its updated IP address information to the IAB-DU via an F1AP message, e.g., GNB-CU CONFIGURATION UPDATE or GNB-DU CONFIGURATION UPDATE ACKNOWLEDGE message.
(2) In some embodiments, the donor CU send its updated IP address information to the IAB-DU via an RRC message, e.g., RRCreconfiguration message.

Yet another of the technical problems solved by embodiments of the disclosed technology is how the donor CU obtains the IAB-DU's updated IP address information.
(1) In some embodiments, after the IAB-DU receives its updated IP address information, it sends the updated IP address information to the donor CU via an FLAP message, e.g., via GNB-DU CONFIGURATION UPDATE, or GNB-CU CONFIGURATION UPDATE ACKNOWLEDGE message.
(2) In some embodiments, the target donor CU sends the IAB-DU's updated IP address information to the source donor CU via an XnAP message, e.g., via a handover (HO) request ACK or new XnAP message.

In the above technical solutions, the updated IP address information includes at least one of the following:
IP address(es) for IPsec for F1-U traffic, and optionally, the corresponding IP address(es) for a GPRS Tunneling Protocol (GTP) endpoints
IP address(es) for IPsec for F1-C traffic
IP address(es) for IPsec for non-F1 traffic
IP address(es) for IPsec for all traffic
Old IP address(es) for IPsec for F1-U traffic
Old IP address(es) for IPsec for F1-C traffic
Old IP address(es) for IPsec for non-F1 traffic
Old IP address(es) for IPsec for all traffic
Backhaul Adaptation Protocol (BAP) address(es) for the IAB node

In some embodiments, after the donor CU and the IAB-DU receive updated IP address information, the donor CU or the IAB-DU establishes the IP security (IPsec) tunnel using the updated IP addresses.

The embodiments described above are also applicable to the CU CP-UP separation scenario, wherein the CU or the donor CU is replaced by the CU-CP.

Examples of Exchanging IP Address Information for CU CP-UP Separation

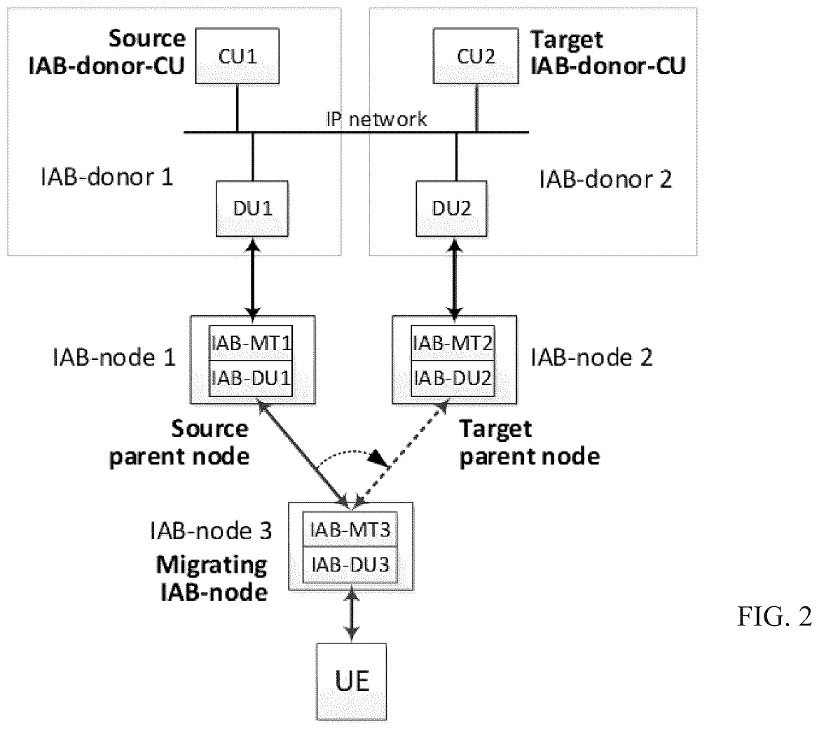

For embodiments that include Central Unit (CU) Control Plane (CP)-User Plane (UP) separation, the CU comprises the CU-CP and CU-UP. An example architecture for the separation of the gNB-CU-UP and gNB-CU-CP for a donor CU is shown in FIG. 3. As shown therein, the CU-CP and CU-UP exchange E1 messages, the gNB-CU-CP transmits F1-C messages to the one or more gNB-DUs, and each of the one or more gNB-DUs transmit messages F1-U messages to the gNB-CU-UP.

One of the technical problems solved by embodiments of the disclosed technology is how the CU-CP obtains the CU-UP's updated IP address information.
(1) In some embodiments, the CU-UP sends its updated IP address information to the CU-CP via an E1 message. In other embodiments, the CU-CP sends the CU-UP's updated IP address information to the IAB-DU using an F1 message.

Another of the technical problems solved by embodiments of the disclosed technology is how the donor CU-UP obtains the IAB-DU's updated IP address information.
(1) In some embodiments, after obtaining the IAB-DU's updated IP address information (e.g., using the embodiments described in the previous section), the CU-CP sends the IAB-DU's updated IP address information to the CU-UP via an E1 message.

Examples of Controlling IAB-DU Transmissions to UEs

In inter-donor migration, all the migrating/descendant IAB-MT and UEs are migrated to a target donor. Typically, a DAPS-like handover is applied to migrating IAB-MT, and a normal handover procedure is applied to descendant IAB-MTs and UEs.

For downlink UE data, the source donor CU shall stop new downlink (DL) data transmission upon reception of a HO request ACK message for the UE. However, some on-the-fly packets sent from the source donor CU might arrive at the UE's serving IAB-DU (e.g., an IAB access node, IAB node 3 in FIG. 2) after reception of the UE context modification message (e.g., due to re-transmission in the backhaul link). Assuming these DL on-the-fly packets sent from source donor CU are forwarded to UE, an error may occur if the UE has already finished Packet Data Convergence Protocol (PDCP) re-establishment and integrity protection is not configured. Otherwise, if integrity protection is configured, these DL on-the-fly packets would be discarded by PDCP sublayer.

In some embodiments, the source donor CU sends an F1AP message (e.g. UE CONTEXT MODIFICATION REQUEST message) to the IAB-DU. The F1AP message includes a transmission action indicator information, which is used to indicate specific actions that can be taken by the gNB-DU for data transmission to the UE. In an example, the transmission action indicator information can be used to indicate that the IAB-DU stop transmission of data sent from source donor CU.

In some embodiments, the F1AP message includes at least one of the following:
information for GTP tunnel(s) that need to be stopped. In an example, the information includes a Transport Network Layer (TNL) address and/or a GTP Tunnel Endpoint ID (TEID).
information for Data Radio Bearer(s) (DRB(s)) that need to be stopped. In an example, the information includes a DRB ID.

In some embodiments, the target donor CU sends an FLAP message to the IAB-DU. The F1AP message includes a transmission action indicator information, which is used to indicate specific actions that can be taken by the gNB-DU for data transmission to the UE. In an example, the transmission action indicator information can be used to indicate at least one of the following:
starting data transmission from the target donor CU
restarting data transmission from the target donor CU
stopping data transmission from the target donor CU

In some embodiments, the F1AP message includes at least one of the following:
information for GTP tunnel(s) that need to be stopped, started, or restarted. In an example, the information includes a Transport Network Layer (TNL) address and/or a GTP Tunnel Endpoint ID (TEID).
information for Data Radio Bearer(s) (DRB(s)) that need to be stopped, started, or restarted. In an example, the information includes a DRB ID.

Example Methods and Embodiments of the Disclosed Technology

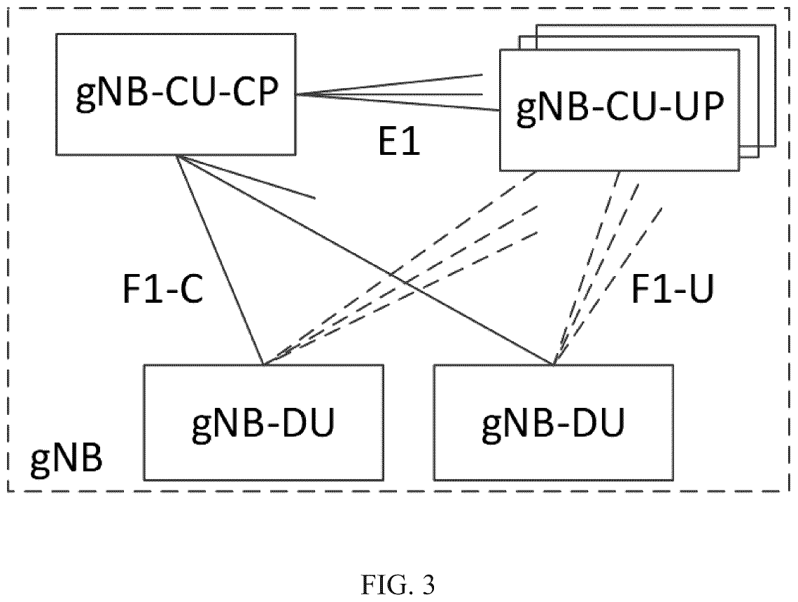

FIG. 4 shows an example of a wireless communication method 400 for IAB donor migration. The method 400 includes, at operation 410, transmitting, by a first integrated access and backhaul (IAB) donor to a second IAB donor, an Xn Application Protocol (XnAP) message comprising an Internet Protocol (IP) address request information.

The method 400 includes, at operation 420, receiving, from the second IAB donor, an IP address information.

In some embodiments, the IP address information comprises at least one of an IP address information of an IAB node, an IP address information of the first IAB donor, or an IP address information of the second IAB donor.

In some embodiments, the XnAP message is an XnAP handover request message.

In some embodiments, the IP address request information is included in a Radio Resource Control (RRC) Context Information Element (IE) in the XnAP handover request message.

In some embodiments, the IP address request information is included in a HandoverPreparationlnformation message in the XnAP handover request message.

In some embodiments, the IP address request information comprises at least one of a number of requested IPv4 addresses, a number of requested IPv6 addresses, a usage of an IPv6 prefix, a usage of the requested IPv4 addresses, a usage of the requested IPv6 addresses, a prior IPv4 address, a prior IPv6 address, or a prior IPv6 prefix.

In some embodiments, IP address information comprises at least one of an IP address for IP security (IPsec) for F1-U traffic, an IP address for IPsec for F1-C traffic, an IP address for IPsec for non-F1 traffic, a prior IP address for IPsec for the F1-U traffic, a prior IP address for IPsec for the F1-C traffic, a prior IP address for IPsec for the non-F1 traffic, an IP address for a General Packet Radio Service (GPRS) Tunneling Protocol (GTP) endpoint, or a Backhaul Adaptation Protocol (BAP) address for an IAB node.

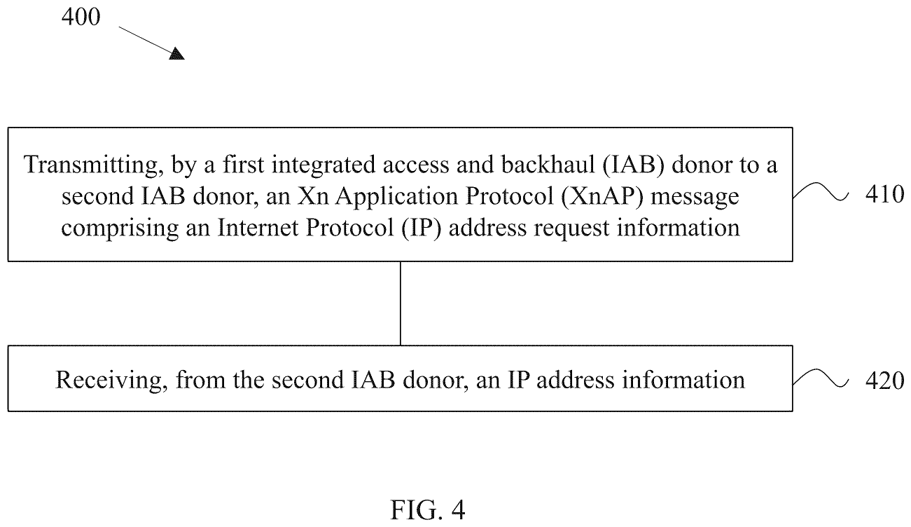

FIG. 5 shows an example of a wireless communication method 500 for IAB donor migration. The method 500 includes, at operation 510, transmitting, by a first integrated access and backhaul (IAB) donor to an IAB node, an F1 Application Protocol (F1AP) message comprising an Internet Protocol (IP) address information, the IP address information comprising at least one of an IP address information of the IAB node, an IP address information of the first IAB donor, and an IP address information of a second IAB donor.

In some embodiments, the IAB node is configured to migrate from the first IAB donor to the second IAB donor.

In some embodiments, the F1AP message is a GNB-CU CONFIGURATION UPDATE message or a GNB-DU CONFIGURATION UPDATE ACKNOWLEDGE message.

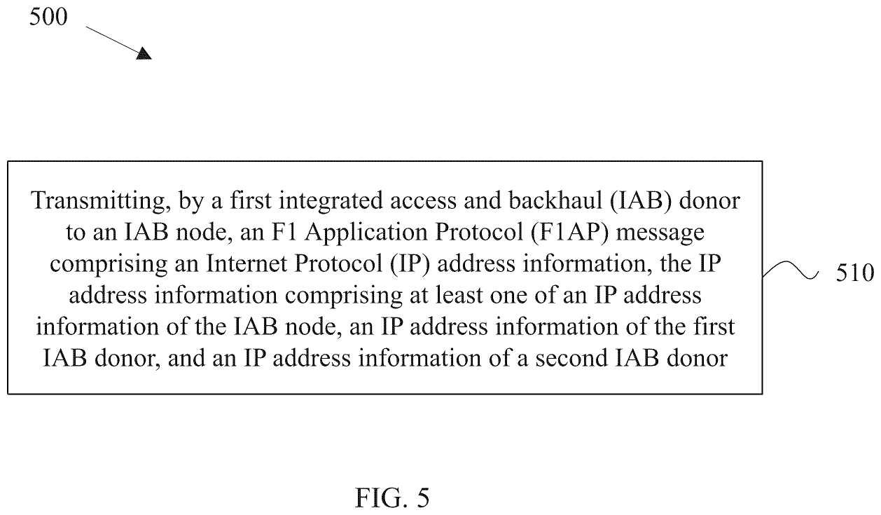

FIG. 6 shows an example of a wireless communication method 600 for IAB donor migration. The method 600 includes, at operation 610, transmitting, by an integrated access and backhaul (IAB) distributed unit (DU) to an IAB donor, a control message comprising an Internet Protocol (IP) address information of the IAB DU.

In some embodiments, the IP address information is used to establish an IP security (IPsec) tunnel.

In some embodiments, the control message is an F1 Application Protocol (FLAP) message or a GNB-DU CONFIGURATION UPDATE message or a GNB-CU CONFIGURATION UPDATE ACKNOWLEDGE message.

In some embodiments, the IP address information comprises at least one of an IP address for IP security (IPsec) for F1-U traffic, an IP address for IPsec for F1-C traffic, an IP address for IPsec for non-F1 traffic, a prior IP address for IPsec for the F1-U traffic, a prior IP address for IPsec for the F1-C traffic, a prior IP address for IPsec for the non-F1 traffic, an IP address for a General Packet Radio Service (GPRS) Tunneling Protocol (GTP) endpoint, or a Backhaul Adaptation Protocol (BAP) address for an IAB node.

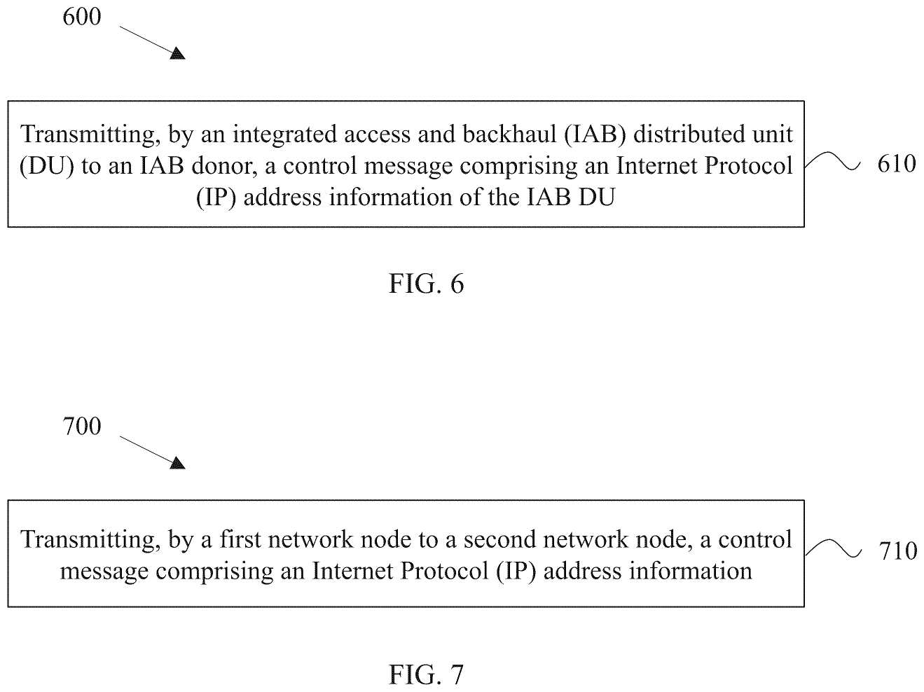

FIG. 7 shows an example of a wireless communication method 700 for IAB donor migration. The method 700 includes, at operation 710, transmitting, by a first network node to a second network node, a control message comprising an Internet Protocol (IP) address information.

In some embodiments, the first network node is a central unit (CU) user plane (UP) and the second network node is a CU control plane (CP), the control message is an E1 message, and the IP address information comprises an IP address information of the first network node.

In some embodiments, the first network node is a central unit (CU) control plane (CP) and the second network node is a CU user plane (UP), the control message is an E1 message, the IP address information comprises an IP address information of a third network node, and the third network node is an IAB node configured to connect to the first network node and the second network node.

In some embodiments, the IP address information comprises at least one of an IP address for IP security (IPsec) for F1-U traffic, a prior IP address for IPsec for the F1-U traffic, an IP address for a General Packet Radio Service (GPRS) Tunneling Protocol (GTP) endpoint, or a Backhaul Adaptation Protocol (BAP) address for the IAB node.

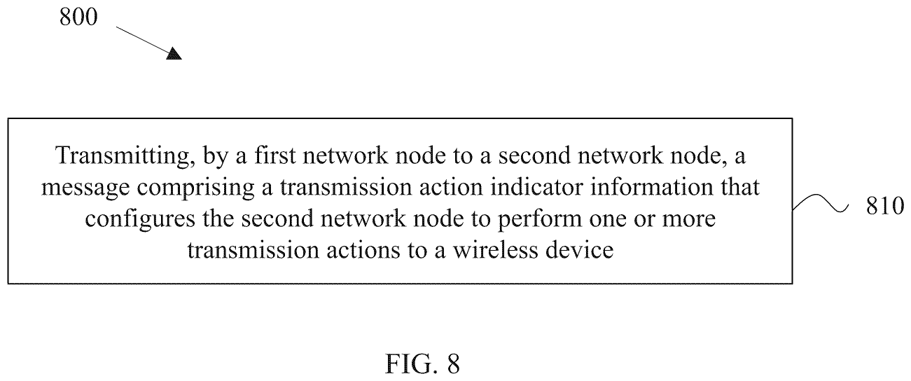

FIG. 8 shows an example of a wireless communication method 800 for IAB donor migration. The method 800 includes, at operation 810, transmitting, by a first network node to a second network node, a message comprising a transmission action indicator information that configures the second network node to perform one or more transmission actions to a wireless device.

In some embodiments, the first network node is a g-NodeB (gNB), a gNB central unit (gNB-CU), a source IAB donor, or a target IAB donor, the second network node is a gNB-DU or an IAB-DU, and the wireless device is a user equipment (UE).

In some embodiments, the transmission action indicator information is configured to indicate at least one of a stopping of data transmission from a source gNB, a starting of data transmission from a target gNB, a restarting of data transmission from the target gNB, or a stopping of data transmission from the target gNB.

In some embodiments, the message comprises (i) an information of one or more General Packet Radio Service (GPRS) Tunneling Protocol (GTP) tunnels that is configured to be started, stopped, or restarted, or (ii) an information of one or more Data Radio Bearers (DRBs) that is configured to be started, stopped, or restarted.

In some embodiments, the information of one of the GTP tunnels comprises a Transport Network Layer (TNL) address or a GTP tunnel endpoint identifier (TEID).

In some embodiments, the information of one of the DRBs comprises a DRB identifier (ID).

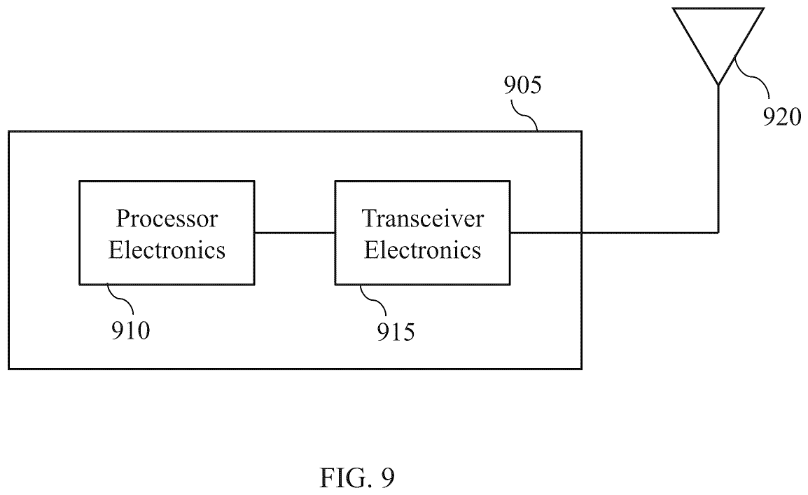

FIG. 9 is a block diagram representation of a portion of an apparatus, in accordance with some embodiments of the presently disclosed technology. An apparatus 905, such as a base station or a wireless device (or UE), can include processor electronics 910 such as a microprocessor that implements one or more of the techniques presented in this document. The apparatus 905 can include transceiver electronics 915 to send and/or receive wireless signals over one or more communication interfaces such as antenna(s) 920. The apparatus 905 can include other communication interfaces for transmitting and receiving data. Apparatus 905 can include one or more memories (not explicitly shown) configured to store information such as data and/or instructions. In some implementations, the processor electronics 910 can include at least a portion of the transceiver electronics 915. In some embodiments, at least some of the disclosed techniques, modules or functions are implemented using the apparatus 905.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
transmitting, by a first integrated access and backhaul (IAB) donor to a second IAB donor, an Xn Application Protocol (XnAP) message comprising an Internet Protocol (IP) address request information; and
receiving, from the second IAB donor, an IP address information.

2. The method of claim 1, wherein the IP address information comprises at least one of an IP address information of an IAB node, an IP address information of the first IAB donor, or an IP address information of the second IAB donor.

3. The method of claim 1, wherein the XnAP message comprises an XnAP handover request message.

4. The method of claim 3, wherein the IP address request information is included in a Radio Resource Control (RRC) Context Information Element (IE) in the XnAP handover request message.

5. The method of claim 3, wherein the IP address request information is included in a HandoverPreparationlnformation message in the XnAP handover request message.

6. The method of claim 1, wherein the IP address request information comprises at least one of a number of requested IPv4 addresses, a number of requested IPv6 addresses, a usage of an IPv6 prefix, a usage of the requested IPv4 addresses, a usage of the requested IPv6 addresses, a prior IPv4 address, a prior IPv6 address, or a prior IPv6 prefix.

7. The method of claim 1, wherein the IP address information comprises at least one of an IP address for IP security (IPsec) for F1-U traffic, an IP address for IPsec for F1-C traffic, an IP address for IPsec for non-F1 traffic, a prior IP address for IPsec for the F1-U traffic, a prior IP address for IPsec for the F1-C traffic, a prior IP address for IPsec for the non-F1 traffic, an IP address for a General Packet Radio Service (GPRS) Tunneling Protocol (GTP) endpoint, or a Backhaul Adaptation Protocol (BAP) address for an IAB node.

8. A method of wireless communication, comprising:
transmitting, by a first integrated access and backhaul (IAB) donor to an IAB node, an F1 Application Protocol (F1AP) message comprising an Internet Protocol (IP) address information,
wherein the IP address information comprises at least one of an IP address information of the IAB node, an IP address information of the first IAB donor, and an IP address information of a second IAB donor.

9. The method of claim 8, wherein the IAB node is configured to migrate from the first IAB donor to the second IAB donor.

10. The method of claim 8, wherein the F1AP message is a GNB-CU CONFIGURATION UPDATE message or a GNB-DU CONFIGURATION UPDATE ACKNOWLEDGE message.

11. An apparatus for wireless communication, comprising:
a processor implemented in a first integrated access and backhaul (IAB) donor; and
a transceiver, coupled to the processor, configured to:
transmit, to a second IAB donor, an Xn Application Protocol (XnAP) message comprising an Internet Protocol (IP) address request information; and
receive, from the second IAB donor, an IP address information.

12. The apparatus of claim 11, wherein the IP address information comprises at least one of an IP address information of an IAB node, an IP address information of the first IAB donor, or an IP address information of the second IAB donor.

13. The apparatus of claim 11, wherein the XnAP message comprises an XnAP handover request message.

14. The apparatus of claim 13, wherein the IP address request information is included in a Radio Resource Control (RRC) Context Information Element (IE) in the XnAP handover request message.

15. The apparatus of claim 13, wherein the IP address request information is included in a HandoverPreparationlnformation message in the XnAP handover request message.

16. The apparatus of claim 11, wherein the IP address request information comprises at least one of a number of requested IPv4 addresses, a number of requested IPv6 addresses, a usage of an IPv6 prefix, a usage of the requested IPv4 addresses, a usage of the requested IPv6 addresses, a prior IPv4 address, a prior IPv6 address, or a prior IPv6 prefix.

17. The apparatus of claim 11, wherein the IP address information comprises at least one of an IP address for IP security (IPsec) for F1-U traffic, an IP address for IPsec for F1-C traffic, an IP address for IPsec for non-F1 traffic, a prior IP address for IPsec for the F1-U traffic, a prior IP address for IPsec for the F1-C traffic, a prior IP address for IPsec for the non-F1 traffic, an IP address for a General Packet Radio Service (GPRS) Tunneling Protocol (GTP) endpoint, or a Backhaul Adaptation Protocol (BAP) address for an IAB node.
